(19) United States
(12) Patent Application Publication
(10) Pub. No.: US 2008/0035049 A1
(43) Pub. Date: Feb. 14, 2008

(54) Boating safety apparatus

(76) Inventors: Kyle P. Johnston, Tucson, AZ (US); Leonard Johnston, Turlock, CA (US)

Correspondence Address: GALASSO & ASSOCIATES, LP, P.O. Box 26503, Austin, TX, 78755-0503, US

(21) Appl. No.: 11/105,110

(22) Filed: Apr. 13, 2005

Related U.S. Application Data
(60) Provisional application No. 60/561,708, filed on Apr. 13, 2004.

(51) Int. Cl. G09F 17/00

(52) U.S. Cl. 116/173

(57) ABSTRACT

A boating safety apparatus comprises a support body, a flag attachment member and a flag. The support body includes an attachment device configured for attaching the support body to another body. The flag attachment member is movably mounted at a first end thereof to the support body. The flag attachment member is movable between a displayed position and a stowed position. The flag is attached to the flag attachment member adjacent the second end of the flag attachment member. The flag is configured for designating an active water sport activity.

### CROSS REFERENCE TO RELATED APPLICATIONS

This patent application claims priority to co-pending U.S. Provisional Patent Application having Ser. No. 60/561,708 filed Apr. 13, 2004 entitled “Easy Flag”, having a common applicant herewith and being incorporated herein in its entirety by reference.

### FIELD OF THE DISCLOSURE

The disclosures made herein relate generally to boating equipment and, more particularly, to safety equipment for boats fulling skiers and wake boarders.

### BACKGROUND

In many states it is now mandatory to display a red flag (i.e., generally referred to herein as a skier notification flag) on boats that are pulling skiers and/or wake boarders. The conventional approach for displaying the red flag is for a person on the boat to manually hold it. For the person having to hold the flag, this detracts from the enjoyment of the boating excursion and increases the likeness that the flag will not be displayed continually while a skier or wake boarder is being pulled behind the boat.

Therefore, an approach for displaying a skier notification flag that overcomes drawbacks associated with conventional approaches for displaying a skier notification flag would be useful, advantageous and novel.

### SUMMARY OF THE DISCLOSURE

Embodiments of the present invention provide a convenient, effective and reliable means for displaying a skier notification flag on a boat. More specifically, embodiments of the present invention provide an apparatus that is configured for enabling the skier notification flag to be selectively displayed and stowed without the need for direct human manipulation of the skier notification flag. Because a device for displaying a skier notification flag in accordance with the present invention does not require direct human manipulation of the skier notification flag, the requirement of displaying the flag does not detracts from the enjoyment of the boating excursion and increases the likeness that the flag will be properly and continually displayed while a skier or wake boarder is being pulled behind the boat. Accordingly, the present invention advantageously overcomes one or more shortcomings associated with conventional approaches for displaying a skier notification flag on a boat and enables regulation compliant of boats pulling skiers and wake boarders.

In one embodiment of the present invention, a boating safety apparatus comprises a support body, a flag attachment member and a flag. The support body includes an attachment device configured for attaching the support body to another body. The flag attachment member is movably mounted at a first end thereof to the support body. The flag attachment member is movable between a displayed position and a stowed position. The flag is attached to the flag attachment member adjacent the second end of the flag attachment member. The flag is configured for designating an active water sport activity. In use the flag attachment member is movable between the stowed position and displayed position, thus, respectively, stowing or displaying the flag.

These and other objects, embodiments advantages and/or distinctions of the present invention will become readily apparent upon further review of the following specification and associated drawings.

### BRIEF DESCRIPTION OF THE DRAWINGS

FIG. 1 depicts a boating safety apparatus in accordance with the present invention.

FIG. 2 depicts the boating safety apparatus of FIG. 1 with a flag attachment member in a displayed position (i.e., flag displayed).

FIG. 3 depicts the boating safety apparatus of FIG. 1 with a flag attachment member in a stowed position (i.e., flag stowed).

### DETAILED DESCRIPTION OF THE DRAWING FIGURES

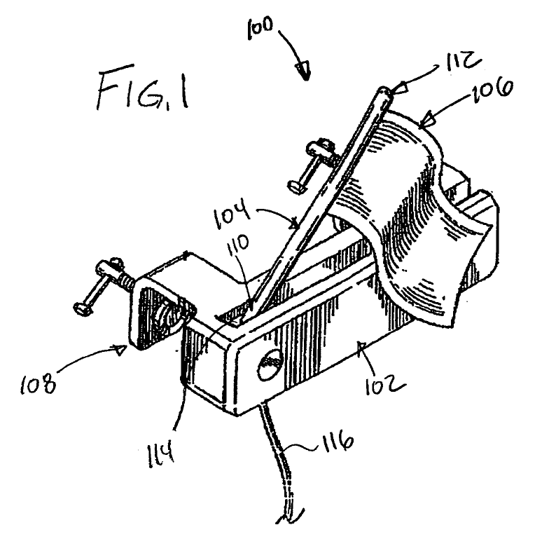

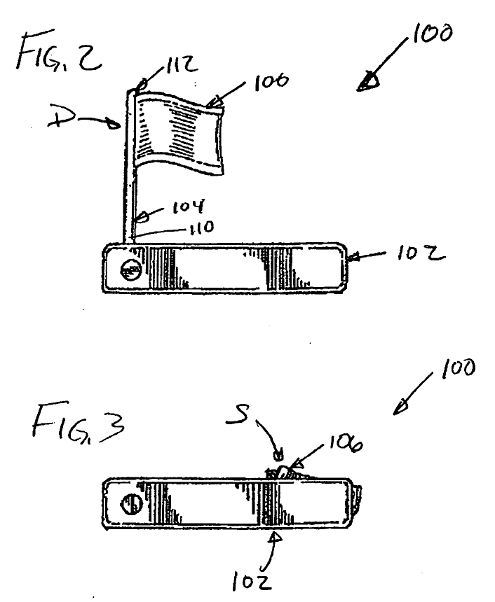

FIGS. 1-3 depict a boating safety apparatus in accordance with the present invention, which is generally referred to herein as the boating safety apparatus 100. The boating safety apparatus 100 comprises a support body 102, a flag attachment member 104 and a flag 106. The support body 102 includes an attachment device 108 configured for attaching the support body 102 to another body (e.g., a hull or railing of a boat). The flag attachment member 104 is movably mounted (e.g., pivotally mounted) at a first end 110 thereof to the support body 102. The flag attachment member 104 is movable between a displayed position D and a stowed position S. The flag 106 is attached to the flag attachment member 104 adjacent the second end 112 of the flag attachment member 104.

The flag 106 is configured for designating an active water sport activity. For example, to comply with certain state requirements, the flag 106 is a red skier notification flag (i.e., a red flag). In use the flag attachment member 104 is movable between the stowed position S and displayed position D, thus, respectively, stowing or displaying the flag 106.

Various components of the boating safety apparatus 100 may be made from materials such as, for example, plastic and aluminium.

In use, the boating safety apparatus 100 mounts to the tower or window on ski and wakeboarding boats. In one embodiment, with the flip of a switch (e.g., connected to the cable 116), the flag attachment member 104 is electrically raised by use of a small motor 114, making it more visible than if someone is holding it. In another embodiment, the flag attachment member is manually moved between the stowed S and displayed D position. From a mechanical/functionality standpoint, the flag attachment member 104 is raised and lowered in the general premise as a windshield wiper except it will remain stationary depending on the position of the switch.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A boating safety apparatus, comprising:
a support body including an attachment device configured for attaching the support body to another body,
a flag attachment member movably mounted at a first end thereof to the support body, wherein the flag attachment member is movable between a displayed position and a stowed position; and
a flag attached to the flag attachment member adjacent the second end of the flag attachment member, wherein the flag is configured for designating an active water sport activity.
